(19) United States
(12) Patent Application Publication
(10) Pub. No.: US 2007/0297505 A1
(43) Pub. Date: Dec. 27, 2007

(54) Method and device for video encoding and decoding

(75) Inventors: Markus Fidler, Eschweiler (DE); Peder J. Emstad, Trondheim (NO); Andrew Perkis, Trondheim (NO)

Correspondence Address: BIRCH STEWART KOLASCH & BIRCH, PO BOX 747, FALLS CHURCH, VA, 22040-0747, US

(73) Assignee: NTNU Technology Transfer, Trondheim (NO)

(21) Appl. No.: 11/798,019

(22) Filed: May 9, 2007

(30) Foreign Application Priority Data
May 10, 2006 (NO) 20062097

(51) Int. Cl. H04B 1/66

(52) U.S. Cl. 375/240

(57) ABSTRACT

The present invention relates to a method and device for providing encoded video data from a video signal. The method comprises the steps of providing intra-coded picture data and predictive-coded picture data, based on the video signal, and generating a first and a second frame of said encoded video data. In the generating step of the intra-coded picture data is arranged in first and second slices in the first and second frames, respectively. The slices are arranged in an overlapping manner in the frames, advantageously with a vertical overlap m_{y} which is equal to or greater than a maximum absolute length of a vertical motion vector. The invention also relates to a corresponding decoding method and device, as well as a corresponding video encoder, a video decoder and a video codec. The invention may be implemented and used in accordance with standard specifications such as H.264. The invention leads to increased network smoothness as well as improved robustness and reduced error propagation during transmission.

### FIELD OF THE INVENTION

The present invention relates in general to the technical field of digital video encoding and decoding.

More specifically, the invention relates to a method, a device and a video encoder for providing encoded video data from a video signal, and a method, a device and a video decoder for providing a decoded video signal from encoded video data. The invention also relates to a method for video encoding and decoding, as well as a video codec.

### BACKGROUND OF THE INVENTION

Digital video signals, in non-compressed form, typically contain very large amounts of data. Due to high temporal and spatial correlations and redundancy, such data may be considerably reduced or compressed by means of video coding. Video coding and decoding processes are thus commonly used to reduce the amount of data which is actually required for certain applications, such as storing the video signals or transmitting signals through a digital communication network.

Some essential prior art specifications for video coding/decoding are indicated below:

H.262 (MPEG-2 Part 2) is commonly used in existing digital video broadcasting and cable television distribution systems, as well as in the DVD standard. The specification supports interlaced and progressive scan video streams. A video frame is separated into one of three matrices of integers: a luminance (Y) matrix and two chrominance channels (Cb, Cr) matrices. Blocks of luminance and chrominance arrays are organized into so-called macroblocks. H.262 involves three types of pictures or frames: Intra-coded (I) pictures, which are coded only with information from within the picture itself, Predictive-coded (P) pictures, which are coded using motion compensated prediction from a previous picture, and Bidirectional predicted (B) pictures, which are coded using motion compensated prediction from previous and future pictures. The I-type pictures encode for spatial redundancy, while P and B type pictures encode for temporal redundancy. A sequence of various picture types are arranged in a structure denoted GOP—Group of Pictures.

H.263 is a specification that is mostly used for videoconferencing, videotelephony and internet video. This specification involves improvement related to compression capability, in particular for achieving a satisfactory quality and performance at low bit rates.

H.264 (MPEG-4 Part 10, AVC) is a video coding/decoding specification which contains several features for obtaining more efficient compression and better performance. Such features include multi-picture motion compensation, variable block size motion compensation (VBSMC), six-tap filtering, quarter-pixel precision for motion compensation, weighted prediction, and more.

The use of motion compensation, such as specified in the above specifications, may have an unfavourable effect on network performance when a coded video signal is transmitted through a digital telecommunication network, in particular a network with variable bit rate transmission such as an IP network. Since the 1-type pictures need significantly more bits for transmission than a P-type or B-type picture, the resulting video stream may become bursty. This may, in turn, lead to poor multiplexing properties, buffer overflow, and large network delays.

N. Wakamiya, M. Murata, and H. Miyahara, “On video coding algorithms with application level QoS guarantees”, Computer Communication Journal, Vol. 23, No. 14-15, pp. 1459-1470, August 2000, describes a prior art method for intra slice coding based on the MPEG-2 specification.

EP-634 878 describes methods for encoding and decoding video data. In the encoded data, the picture is divided into a plurality of intra slices, each including intra coded picture data.

The H.262 specification also suggests the use of slices, which is defined as a consecutive series of macroblocks which are all located in the same horizontal row. The specification (section 6.1.2) clearly states that slices shall not overlap.

A disadvantage of the intra slice coding approaches suggested in the prior art is that errors due to an accidental data loss may propagate through numerous frames in the encoded video data. Such error propagation may result in poor robustness.

### SUMMARY OF THE INVENTION

The present patent application is directed to methods and devices as set forth in the appended independent claims.

Specific embodiments and further details are set forth in the dependent claims.

Additional features and principles of the present invention will be recognized from the detailed description below.

It is to be understood that both the foregoing general description and the following detailed description are exemplary and explanatory only and are not restrictive of the invention, as claimed.

Methods and devices in accordance with the principles of the present invention may overcome at least some of the disadvantages of the background art.

Methods and devices in accordance with the principles of the present invention may lead to improved smoothness of the network traffic.

Methods and devices in accordance with the principles of the present invention may involve reduced error propagation and improved robustness against data loss, while still maintaining improved smoothness of the network traffic.

### BRIEF DESCRIPTION OF THE DRAWINGS

The accompanying drawings illustrate an embodiment of the invention. In the drawings,

FIG. 1 is a schematic block diagram illustrating principles of the invention,

FIG. 2 is a schematic flow chart illustrating an encoding method,

FIG. 3 is a schematic flow chart illustrating a decoding method, and

FIG. 4 is a schematic block diagram illustrating a video codec.

### DETAILED DESCRIPTION OF THE INVENTION

Reference will now be made in detail to the present invention, examples of which are illustrated in the accompanying drawings. Wherever possible, the same reference numbers will be used throughout the drawings to refer to the same or like parts.

In the following description, the expression “predictive-coded data” should for simplicity be interpreted as both regular predictive-coded data, which are coded using motion compensated prediction from previous pictures, and bidirectional predictive data, i.e. data coded using motion compensated prediction from both previous and future pictures.

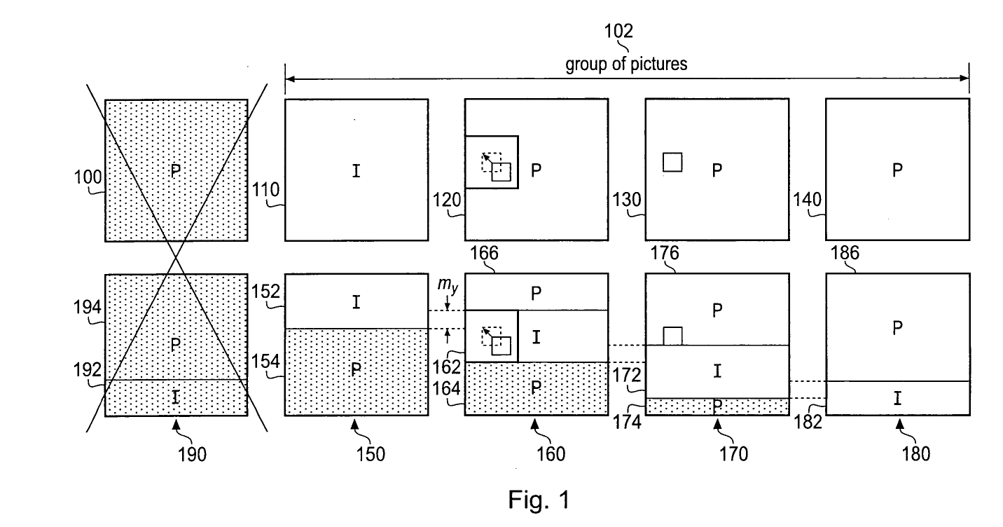

FIG. 1 is a schematic block diagram illustrating principles of the invention.

The upper row of squares 100, 110, 120, 130, 140 are intended to represent the principles of prior art video coding, such as video coding in accordance with the H.262 specification. In the upper row, 100 denotes frame number n, 110 denotes frame number n+1, 120 denotes frame number n+2, 130 denotes frame number n+3, and 140 denotes frame number n+4. The frames 110, 120, 130, and 140 constitute a so-called Group of Pictures (GOP) 102.

In this simplified example, the frame 110 is an intra-coded frame (I-type frame), i.e. a frame which comprises data that is coded with information from within the corresponding original (uncompressed, uncoded) picture. The whole frame 110 is filled with intra-coded data.

The next frame 120 is a predictive-coded frame (P-type frame), i.e. a frame which is coded using motion-compensated prediction from a previous picture in the original (uncompressed, uncoded) video signal.

The subsequent frames 130 and 140 are also predictive-coded frames (P-type frames).

The result of this traditional approach is that the resulting stream of coded video data will include a combination of large 1-type frames, such as frame 110, which are represented with a large number of bits, and smaller P-type frames, such as frames 120, 130, 140, which are represented by a much smaller number of bits. This may lead to distortion, delay jitter and non-smoothness when the coded data are transmitted through a digital communication network, in particular in the case of variable-bit video streaming through packet-based networks, e.g. IP networks such as the Internet.

A coding approach in accordance with certain aspects of the invention has been illustrated by the lower row of squares in FIG. 1. The lower row of squares 190, 150, 160, 170, and 180 are thus intended to represent principles of certain aspects of the present invention. In the lower row, 190 denotes frame number n, 150 denotes frame number n+1, 160 denotes frame number n+2, 170 denotes frame number n+3, and 180 denotes frame number n+4. The frames 150, 160, 170, and 180 constitute a Group of Pictures (GOP).

The first frame 190, preceding the GOP 102, may be regarded as the final frame in a foregoing group of pictures. The first frame 190 includes the slice 192 which contains intra-coded data, while the remaining part 194 of the frame 190 contains predictive-coded data.

In the GOP 102, each frame 150, 160, 170, and 180 comprises a slice which contains intra-coded data, while the remaining part of the frame contains predictive-coded data.

Thus, the frame 150 is not a purely intra-coded frame, but a combination of a predicted-coded frame and an intra-coded frame, as the frame 150 includes the slice 152 which contains intra-coded data, while the remaining part 154 of the frame 150 contains predictive-coded data.

Likewise, the subsequent frame 160 includes the slice 162 which contains intra-coded data, while the remaining parts 164 and 166 of the frame 160 contain predictive-coded data.

Also, the subsequent frame 170 includes the slice 172 which contains intra-coded data, while the remaining parts 174 and 176 of the frame 170 contain predictive-coded data.

The last frame 180 in the GOP includes the slice 182 which contains intra-coded data, while the remaining part 186 of the frame 180 contains predictive-coded data.

A result of the invention is the abandonment of large, intra-coded frames (possibly except from the very first frame of the sequence, which is a transient). Instead the resulting sequence of coded frames comprises combined frames which mainly consist of predictive-coded data, with intra-coded data slices inserted. This results in a homogenous spreading of the intra-coded data through the whole group of pictures, which in turn leads to a significantly smoother video stream when the coded video data is transferred through a communication network.

Consistent with an embodiment, the slices 152, 162, 172, and 182 that contain intra-coded data are arranged in an overlapping manner with respect to each other. This results in further robustness and limited error propagation.

The overlapping approach has certain effects in the case of an accidental data loss during a transmission of encoded video data. In such a case, the overlap ensures that errors will not propagate back into areas of the frame where they have been removed just before by an intra-coded slice. The overlapping approach may also have other effects.

Consider, for example, the case that the frame 190 is accidentally lost, e.g. due to a transmission fault (illustrated by the crossing-out to the left in FIG. 1). Then, the shaded P-areas 154, 164, and 174 indicate predictive-coded data that may be corrupted due to error propagation. However, as a result of the overlapping m_{y}, the loss error will not propagate infinitely. Rather, valid predictive-coded data will soon be recovered, and the loss error will die out.

Consistent with an embodiment, the overlapping, denoted m_{y} in FIG. 1, is equal to or greater than a maximum absolute length of a vertical motion vector.

Consistent with an embodiment, the overlapping m_{y} is set substantially equal to the maximum absolute length of a vertical motion vector. The overlapping m_{y} may be set to a value calculated as the maximum absolute length of the motion vectors in vertical direction.

Consistent with an embodiment, the slices are horizontal. Each slice may extend through the entire picture width of the video signal.

As appears from FIG. 1, a slice in one frame (such as the slice 152) is followed by a vertically lower slice in the subsequent frame (such as the slice 162). However, when a slice has reached the bottom of a certain frame, the next slice will appear in the upper part of the next frame.

Consistent with a feature of the invention, the slices vertically sweep the entire frame height through the course of a Group of Pictures (GOP)

The number of four frames in a Group of Pictures (GOP) has been selected for simplicity of illustration and explanation. The skilled person will readily realize that a larger number of frames may alternatively be used in a GOP, such as 8, 12, or 16, according to the relevant application scenario. However, it should be appreciated that the principles of the invention are also applicable in case of fewer frames in a GOP, such as three or two. Thus, in a particular embodiment, only two frames of encoded video data are provided during the encoding process, and the intra-coded picture data is distributed among those two frames.

Moreover, only one intra-coded slice has been illustrated in each combined frame 150, 160, 170 and 180. The skilled person will however readily realize that more than one intra-coded slice may be included in each frame, such as 2, 3, 4, 5 or more, still consistent with features of the present invention.

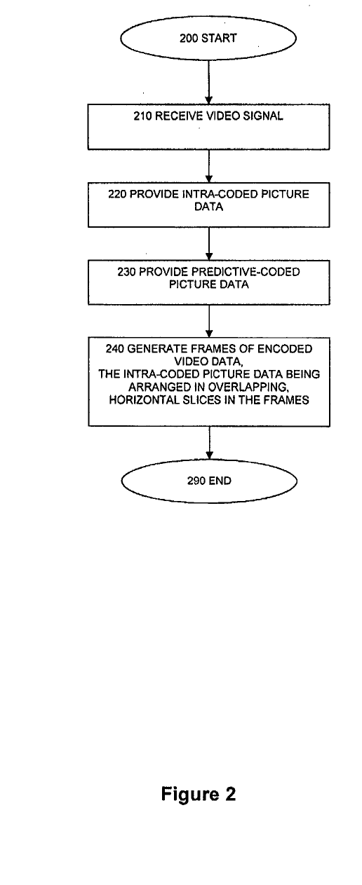

FIG. 2 is a schematic flow chart illustrating an encoding method according to an embodiment of the present invention.

The illustrated method is a computer-implemented process, typically executed by a processor in a video encoder. The term video decoder should be understood as including any device suitable or adapted for providing encoded video data from a video signal. The method starts at the initial step 200.

First, in step 210, a video signal is received by the video encoder.

Next, in step 220, the video encoder provides intra-coded picture data and predicted picture data, based on the received video signal.

Next, in step 230, the video encoder provides predictive-coded picture data based on the received video signal.

Next, in step 240, the video encoder generates a first frame and a second frame of said encoded video data. This generating step includes arranging the intra-coded picture data in first and second slices in said first and second frames, respectively. In particular, consistent with an embodiment of the invention, the slices are arranged in an overlapping manner in the first and second frames.

Consistent with an embodiment, the above substep of arranging the intra-coded picture data in first and second slices comprises to arrange the first and second slices with an overlapping m_{y} which is equal to or greater than a maximum absolute length of a vertical motion vector.

Consistent with an embodiment, the overlapping m_{y} is set substantially equal to the maximum absolute length of a vertical motion vector. The overlapping m_{y} may be set to a value calculated as the maximum absolute length of the motion vectors in vertical direction.

Consistent with an embodiment, the overlapping slices are arranged horizontally in the picture. Each slice may extend through the entire picture width of the video signal.

Consistent with an embodiment, the second slice is arranged vertically lower than said first slice.

Consistent with an embodiment, the encoding method is implemented in conformity with the MPEG-4 Part 10/H.264 specification.

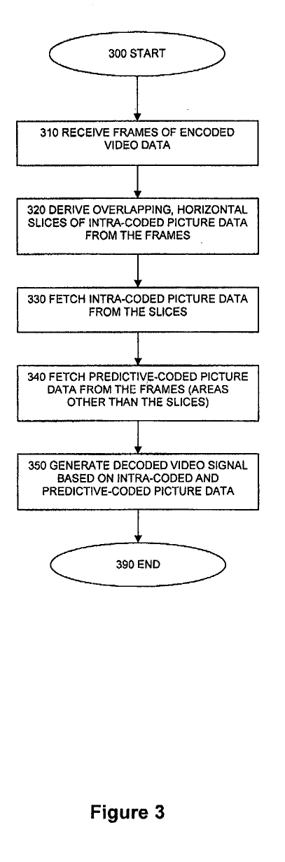

FIG. 3 is a schematic flow chart illustrating a decoding method according to the principles of the present invention.

The illustrated method is a computer-implemented process, typically executed by a processor in a video decoder. The term video decoder should be understood as any device suitable or adapted for providing a decoded video signal from video data. The method starts at the initial step 300.

First, in step 310, a number of frames of encoded video data are received by the video decoder. The frames comprises at least a first and a second frame.

Next, in step 320, slices of intra-coded picture data are derived from the at least first and second frames. Consistent with an embodiment, the slices are arranged in an overlapping manner in the first and second frames. Consistent with an embodiment, the slices are arranged horizontally in the picture.

Consistent with an embodiment, the first and second slices are arranged with an overlapping m_{y} which is equal to or greater than a maximum absolute length of a vertical motion vector.

Consistent with an embodiment, the overlapping m_{y} is set substantially equal to the maximum absolute length of a vertical motion vector. The overlapping m_{y} may be set to a value calculated as the maximum absolute length of the motion vectors in vertical direction.

Consistent with an embodiment, each slice extends through the picture width of the video signal. In particular, the second slice may be arranged vertically lower than the first slice.

Next, in step 330, intra-coded picture data is fetched from the overlapping slices.

Next, in step 340, predictive-coded picture data is fetched from the frames with the exception of said slices, i.e. from picture areas other than the areas covered by the slices.

Next, in step 350, the decoded video signal is generated based on the intra-coded picture data and the predictive-coded picture data.

Consistent with an embodiment, the decoding method is implemented in conformity with the MPEG-4 Part 10/H.264 specification.

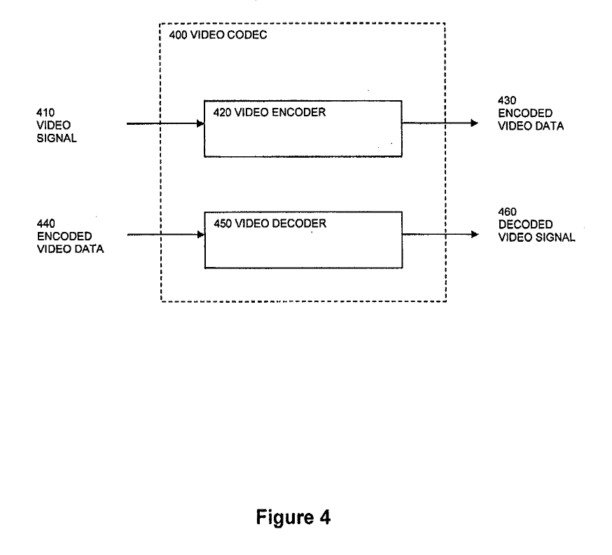

FIG. 4 is a schematic block diagram illustrating a video codec in accordance with an aspect of the invention.

The video codec 400 comprises a video encoder 420 and a video decoder 430, both implemented in accordance with aspects of the invention, e.g. by the teaching of the above detailed description.

The encoder 420 comprises a data input which is supplied with the video signal 410 that shall be encoded. The encoder provides coded video data at its output 430.

The decoder 450 comprises a data input which is supplied with encoded video data 440 that shall be decoded. The decoder provides a decoded video signal at its output 460.

The encoder 420 and the decoder 450 may be implemented as software modules that comprises computer program code which is executed by common hardware equipment, in particular a microprocessor. The encoder 420 and the decoder 450 may e.g. be integrated in a common video codec software module, or implemented as separate software modules, according to the application in question.

A particular result of the present invention is that it may readily be implemented in compliance with the requirements of the MPEG-4 Part 10/H.264 specification.

The present invention may be used in various applications, such as coding and decoding of video information in relation to video transmission via computer networks such as the Internet, or via communication networks such as GSM/GPRS, UMTS/3G mobile communication networks etc. Coding and decoding in accordance with the invention may also be used as part of video conferencing systems, or in connection with the use of mobile terminals such as mobile phones or PDAs. Other possible applications include decoding in television equipment such as SDTV or HDTV television apparatus, or in digital video recording equipment, or in home cinema systems. The invention is however not limited to such applications.

The above detailed description of the invention has been presented for illustration purposes. It is not exhaustive and does not limit the invention to the precise form disclosed. Modifications and variations are possible in light of the above teachings or may be acquired from the practicing of the invention.

1. Method for providing encoded video data from a video signal, the method comprising the steps of
providing intra-coded picture data and predicted picture data, based on the video signal,
generating a first and a second frame of said encoded video data, including arranging said intra-coded picture data in first and second slices in said first and second frames, respectively,
the slices being arranged in an overlapping manner in said first and second frames.

2. Method according to claim 1,
wherein said step of arranging said intra-coded picture data comprises
arranging said first and second slices with an overlapping m_{y} which is equal to or greater than a maximum absolute length of a vertical motion vector.

3. Method according to claim 2,
wherein said overlapping m_{y} is equal to a maximum absolute length of a vertical motion vector.

4. Method according to claim 2,
wherein said slices are horizontal.

5. Method according to claim 2,
wherein said slices extends through the picture width of the video signal.

6. Method according to claim 2,
wherein said second slice is arranged vertically lower than said first slice.

7. Method according to claim 1, implemented in conformity with the MPEG-4 Part 10/H.264 specification.

8. Video encoder,
configured to perform a method in accordance with claim 1.

9. Device for providing encoded video data from a video signal, comprising a processing device that is configured to perform a method in accordance with claim 1.

10. Method for providing a decoded video signal from encoded video data, the encoded video data comprising a first and a second frame, the method comprising the steps of
deriving slices from said first and second frames, the slices being arranged in an overlapping manner in said first and second frames,
providing intra-coded picture data from said slices,
providing predictive-coded picture data from said frames with the exception of said slices, and
generating said decoded video signal based on said intra-coded picture data and said predicted picture data.

11. Method according to claim 10,
wherein said first and second slices are arranged with an overlapping m_{y} which is equal to or greater than a maximum absolute length of a vertical motion vector.

12. Method according to claim 11, wherein said overlapping m_{y} is equal to the maximum absolute length of a vertical motion vector.

13. Method according to claim 11,
wherein said slices are horizontal.

14. Method according to claim 11,
wherein said slices extends through the picture width of the video signal.

15. Method according to claim 11,
wherein said second slice is arranged vertically lower than said first slice.

16. Method according to claim 10,
implemented in conformity with the AVC/H.264 specification.

17. Video decoder,
configured to perform a method in accordance with claim 10.

18. Device for providing a decoded video signal from encoded video data, comprising a processing device that is configured to perform a method in accordance with claim 10.

19. Method for video encoding and decoding, comprising
steps for providing encoded video data from a video signal in accordance with claim 1, and
steps for providing a decoded video signal from said encoded video data including:
deriving slices from said first and second frames, the slices being arranged in an overlapping manner in said first and second frames,
providing intra-coded picture data from said slices,
providing predictive-coded picture data from said frames with the exception of said slices, and
generating said decoded video signal based on said intra-coded picture data and said predicted picture data.

20. Video codec, comprising
a video encoder, configured to perform a method in accordance with claim 1, and
a video decoder configured to perform a method for providing a decoded video signal from encoded video data, the encoded video data comprising a first and a second frame, the method comprising the steps of
deriving slices from said first and second frames, the slices being arranged in an overlapping manner in said first and second frames,
providing intra-coded picture data from said slices,
providing predictive-coded picture data from said frames with the exception of said slices, and
generating said decoded video signal based on said intra-coded picture data and said predicted picture data.
